(19) United States
(12) Patent Application Publication
(10) Pub. No.: US 2017/0212942 A1
(43) Pub. Date: Jul. 27, 2017

(54) DATABASE GRID SEARCH METHODS AND SYSTEMS

(71) Applicant: SOLUFY INFORMATION TECHNOLOGIES INC., OTTAWA (CA)

(72) Inventor: MARIO BOILEAU, BOURGET (CA)

(21) Appl. No.: 15/412,428

(22) Filed: Jan. 23, 2017

Related U.S. Application Data
(60) Provisional application No. 62/281,802, filed on Jan. 22, 2016.

(51) Int. Cl. G06F 17/30

(52) U.S. Cl. CPC G06F 17/30554; G06F 17/30572

(57) ABSTRACT

Databases are organized collections of data to model aspects of reality and support processes including those requiring, generating, and finding information or modelling real or virtual world systems. These are typically accessed via an application which may have been coded to only return specific columns or limits functionality requiring the user to either know names of desired fields or search the entire table. Such applications allow users who are not knowledgeable with Structured Query Language (SQL) for managing data held in a relational database management systems (RDBMSs) to access the database. However, the application may be coded to return only specific columns or limit accessible functionality. These issues are further exacerbated through user interfaces mobile/portable devices which typically present a smaller portion of the grid. Embodiments of the invention provide users with a means to perform a search for a specific column or columns without requiring the user be a programming language expert or exploit a database supporting SQL.

### CROSS-REFERENCE TO RELATED APPLICATIONS

This patent application claims the benefit of U.S. Provisional Patent Application 62/281,802 filed Jan. 22, 2016, currently pending, entitled “Database Grid Search Methods and Systems.”

### FIELD OF THE INVENTION

This invention relates to databases and more specifically to providing users with a search capability in respect of the grid columns within such databases.

### BACKGROUND OF THE INVENTION

A database is an organized collection of data, typically a collection of schemas, tables, queries, reports, views and other objects. This data is typically organized to model aspects of reality in a way that supports processes including, for example, those requiring information, generating information, finding information, modelling real world systems and modelling virtual systems.

Formally, a “database” refers to a set of related data and the way it is organized. Access to these data is usually provided by a “database management system” (DBMS) consisting of an integrated set of computer software that allows users to interact with one or more databases and provides access to all of the data contained in the database (although restrictions may exist that limit access to particular data). The DBMS provides various functions that allow entry, storage and retrieval of large quantities of information and provides ways to manage how that information is organized. Due to the close relationship between them, the term “database” is often used casually to refer to both a database and the DBMS used to manipulate it.

Outside the world of professional information technology, the term database is often used to refer to any collection of related data, such as a spreadsheet or a card index for example. Prior art DBMSs provide various functions that allow for the management of a database and its data which can be classified into four main functional groups:
Data definition—Creation, modification and removal of definitions that define the organization of the data;
Update—Insertion, modification, and deletion of the actual data;
Retrieval—Providing information in a form directly usable or for further processing by other applications. The retrieved data may be made available in a form basically the same as it is stored in the database or in a new form obtained by altering or combining existing data from the database; and
Administration—Registering and monitoring users, enforcing data security, monitoring performance, maintaining data integrity, dealing with concurrency control, and recovering information that has been corrupted by some event such as an unexpected system failure.

Both a database and its DBMS conform to the principles of a particular database model. A “database system” refers collectively to the database model, database management system, and database. Physically, database servers are dedicated computers that hold the actual databases and run only the DBMS and related software where these are typically multiprocessor computers, with generous memory and redundant array of inexpensive disks (RAID) arrays used for stable storage. RAID is used for recovery of data if any of the disks fail. Hardware database accelerators, connected to one or more servers via a high-speed channel, are also used in large volume transaction processing environments. DBMSs are found at the heart of most database applications. DBMSs may be built around a custom multitasking kernel with built-in networking support, but modern DBMSs typically rely on a standard operating system to provide these functions.

Databases and DBMSs are generally categorized according to the database model(s) that they support (such as relational or Extensible Markup Language (XML)), the type(s) of computer they run on (from a server cluster to a mobile phone), the query language(s) used to access the database (such as SQL or XQuery), and their internal engineering, which affects performance, scalability, resilience, and security.

Within this document the inventors refer to a “grid” which is the typical format that the information within a database is presented to a user either discretely or in combination with other visual tools, such as graphs for example. Today's modern grid controls, are powerful user interface (UI) controls commonly used in most desktop and web applications to display large amounts of data in a tabular format, i.e. organizing that data by rows and columns. These grid controls offer powerful features like sorting and filtering the data very efficiently, and some of them even allow the user to search for the data within the grid, using the very common Search Dialog, which is found in pretty much every text editor. However, no matter how powerful the grid control is, or how powerful the host application is, none of them allows the user to search for a specific column in the grid. Obviously for a grid that only has a few columns, this might not seem like an issue. However, a large number of users in addition to database administrators (DBAs) globally must deal with very large data grids on a daily basis, data grids which can range from tens to hundreds to thousands or more of columns and the same or more in rows. As these columns are generally arranged based upon the application, user preference, structure of the database etc. then these are very rarely sorted alphabetically, and accordingly there is no typically no way to know where a given column is in the grid even where the user exploits the database routinely.

Therefore, the only way the user can find the desired column is by manually scrolling the horizontal scroll bar until the user finds the column. The problem unfortunately doesn't stop there as generally the user is not interested in the contents of a single column but multiple columns. This means that the user normally has to find several other columns in the same tedious and non-efficient manner, in order to achieve the task at hand, which is normally to look at the data, analyze it, try to find errors or anomalies in the data, troubleshoot an application's error, etc.

If the user is knowledgeable of Structured Query Language (SQL, a special-purpose programming language designed for managing data held in a relational database management systems (RDBMSs), then they may be able to write a database query. However, the vast majority of users are not familiar with this language at all yet alone competent enough to generate a working query. Further, this situation is even worse where the user is accessing the database through an application that has been coded to only return specific columns, e.g. to return 230 columns or alternatively the user is exploiting a database tool that limits the functionality accessible such that if the user does not know the name of the desired fields then they must search the entire table to find the required column(s). All of these issues are further exacerbated when the user is working through a UI on a mobile/portable device which is typically significantly smaller in terms of the display presenting the grid to the user.

Accordingly, it would be beneficial to provide users with a means to perform a search for a specific column or columns without requiring that the user is a programming language expert and exploiting a database supporting SQL. It would be beneficial to provide the features within any grid(s) within any type of application, e.g. desktop, web-based, or mobile, irrespective of the system and/or device etc.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating to databases and more specifically to providing users with a search capability in respect of the grid columns within such databases.

In accordance with an embodiment of the invention there is provided a method comprising:
providing a database management system in execution upon a computer system comprising at least a microprocessor coupled to a server via a communications network, the server comprising a database;
receiving from a user one or more search terms into a search dialogue provided by the database management system to the user, wherein the search terms relate to at least one of a key, a caption and a name; and
providing to the user a predetermined portion of the database in dependence upon the received one or more search terms.

In accordance with an embodiment of the invention there is provided a system comprising
an electronic device coupled to a communications network executing a database management application stored within a non-transitory memory of the electronic device;
a remote server coupled to the communications network;
a database stored within the memory; wherein
the database management software comprises executable computer instructions associated with a process comprising the steps of:
   receiving upon the electronic device from the user one or more search terms via a search dialogue provided by the database management application to the user, wherein the search terms relate to at least one of a key, a caption and a name;
   retrieving a predetermined portion of the database from the remote server in dependence upon the received one or more search terms; and
   displaying the predetermined portion of the database to user upon the electronic device.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3 depicts a block diagram schematic of a general desktop database associated with a desktop database program having an integrated user interface (UI) according to an embodiment of the invention;

FIG. 4 depicts an exemplary screenshot of a database program having a graphical user interface (GUI) capability;

FIG. 5A depicts an exemplary screen layout of a database grid presented to a user within a prior art GUI;

FIG. 5B depicts a prior art search within a database application which does not find a column title; and

FIG. 6 depicts exemplary user GUI images for a user accessing and searching a database exploiting a column search feature according to an embodiment of the invention.

### DETAILED DESCRIPTION

The present invention is directed to databases and more specifically to providing users with a search capability in respect of the grid columns within such databases.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™)

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals whose biometric data may be, but not limited to, monitored, acquired, stored, transmitted, processed and analysed either locally or remotely to the user wherein by their engagement with a service provider, third party provider, enterprise, social network, social media etc. via a dashboard, web service, website, software plug-in, software application, graphical user interface acquires, for example, electronic content. This includes, but is not limited to, private individuals, employees of organizations and/or enterprises, members of community organizations, members of charity organizations, men, women, children, teenagers, and animals. In its broadest sense the user may further include, but not be limited to, software systems, mechanical systems, robotic systems, android systems, etc. that may be characterised by an ability to extract and process content presented and associate to defined actions etc.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” as used herein may refer to, but is not limited to, relates to miniature electronic devices that are worn by the user including those under, within, with or on top of clothing and are part of a broader general class of wearable technology which includes “wearable computers” which in contrast are directed to general or special purpose information technologies and media development.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

Reference to a “grid” as used herein may refer to, but is not limited to, any tabular, columnar, or other logical arrangement of data stored within a database as displayed to the user wherein a row, column, or other aspect of the grid relates to data having a common relationship within the database. For example, within a Microsoft™ Excel spreadsheet data may be presented as a grid which is a two-dimensional (2D) table with rows and columns.

Reference to a “database” as used herein may refer to, but is not limited to, any organized collection of data. A database may include, but not be limited to, a collection of schemas, tables, queries, reports, views and other objects. Generally, databases can be divided into data sources, data consumers, actionables, etc. More specifically, each database may have one or more large structured sets of persistent data. These structured sets of persistent data are usually termed data sources. A data source is thus a type of object for a database. Data consumers are other types of database objects; examples of data consumers are data processing objects, data formatting objects, data input objects, etc. Data sources actually store the data of a given database, and the data consuming object types provide some kind of view on or of the stored data. Example descriptions of the above-mentioned database object types are provided below. First, data sources are sets of like data that can be described by one schema. More specifically, a data source is usually a set of similar records. Second, data processing objects represent a search on stored data. More specifically, a data processing object is usually a set of rules for retrieving data from one or more data sources. Third, data formatting objects present data from a data source or a data processing object in a formatted fashion. More specifically, a data formatting object is usually a set of rules for formatting retrieved data. Fourth, data input objects provide a simplified mechanism for inputting data into at least one data source. More specifically, a data input object is usually a document or similar displayable file that provides a relatively quick and easy mechanism to modify and/or insert records into a database using an intuitive, graphical environment. Data input objects can also be used to filter and/or view data of a database.

Reference to “content information” as used herein may refer to, but is not limited to, any combination of content features, content serving constraints, information derivable from content features or content serving constraints (referred to as “content derived information”), and/or information related to the content (referred to as “content related information”), as well as an extension of such information (e.g., information derived from content related information).

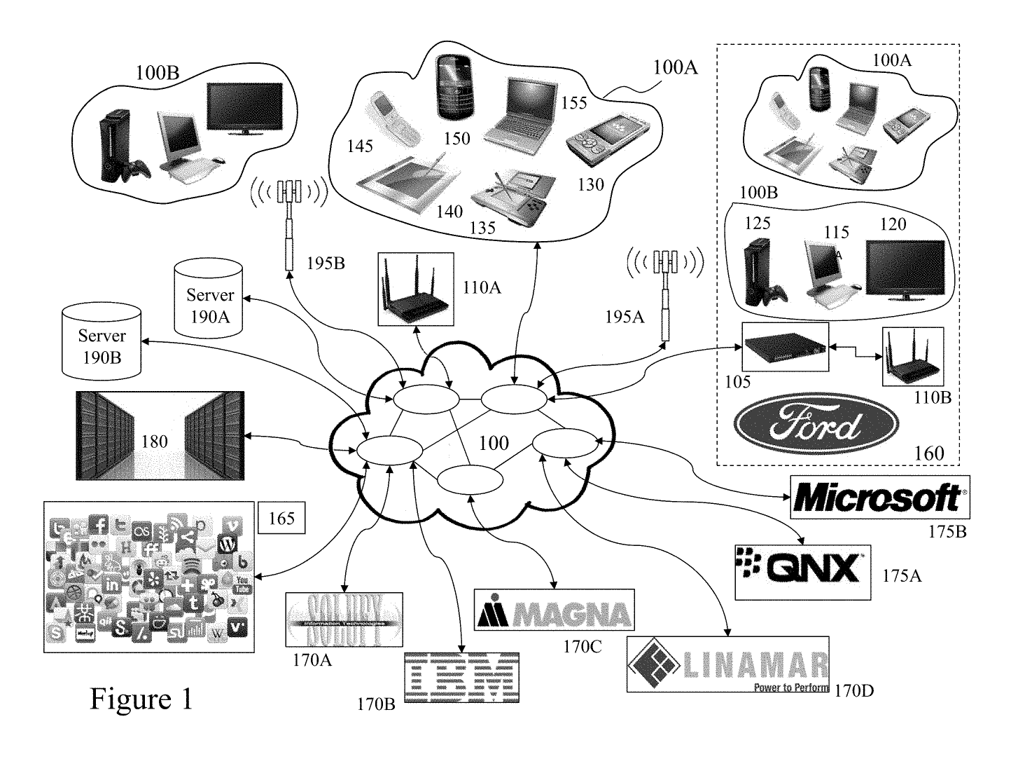

Referring to FIG. 1 there is depicted a network environment 100 within which embodiments of the invention may be employed supporting planning systems and planning applications/platforms (DAPs) according to embodiments of the invention. Such DAPs, for example supporting multiple channels and dynamic content. As shown first and second user groups 100A and 100B respectively interface to a telecommunications network 100. Within the representative telecommunication architecture, a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, e.g. Ford™, within which other first and second user groups 100A and 100B are present. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.10, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 and Bluetooth as well in an ad-hoc manner.

Also connected to the network 100 are Social Networks (SOCNETS) 165, first and second software providers 170A and 170B respectively, e.g. Solufy™ and IBM™, first and second suppliers 170C and 170D, e.g. Magna™ and Linamar™, and first to second online service providers 175A and 175B respectively, e.g. QNX™ and Microsoft™, as well as first and second servers 190A and 190B which together with others, not shown for clarity. First and second servers 190A and 190B may host according to embodiments of the inventions multiple services associated with a provider of database applications/platforms (DAPs); a provider of a SOCNET or Social Media (SOME) exploiting DAP features; a provider of a SOCNET and/or SOME not exploiting DAP features; a provider of services to PEDS and/or FEDS; a provider of one or more aspects of wired and/or wireless communications; an Enterprise 160 exploiting DAP features; license databases; content databases; image databases; content libraries; customer databases; websites; and software applications for download to or access by FEDs and/or PEDs exploiting and/or hosting DAP features. First and second primary content servers 190A and 190B may also host for example other Internet services such as a search engine, financial services, third party applications and other Internet based services.

Accordingly, a user may exploit a PED and/or FED within an Enterprise 160, for example, and access one of the first or second primary content servers 190A and 190B respectively to perform an operation such as accessing/downloading an application which provides DAP features according to embodiments of the invention; execute an application already installed providing DAP features; execute a web based application providing DAP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi nodes 110A.

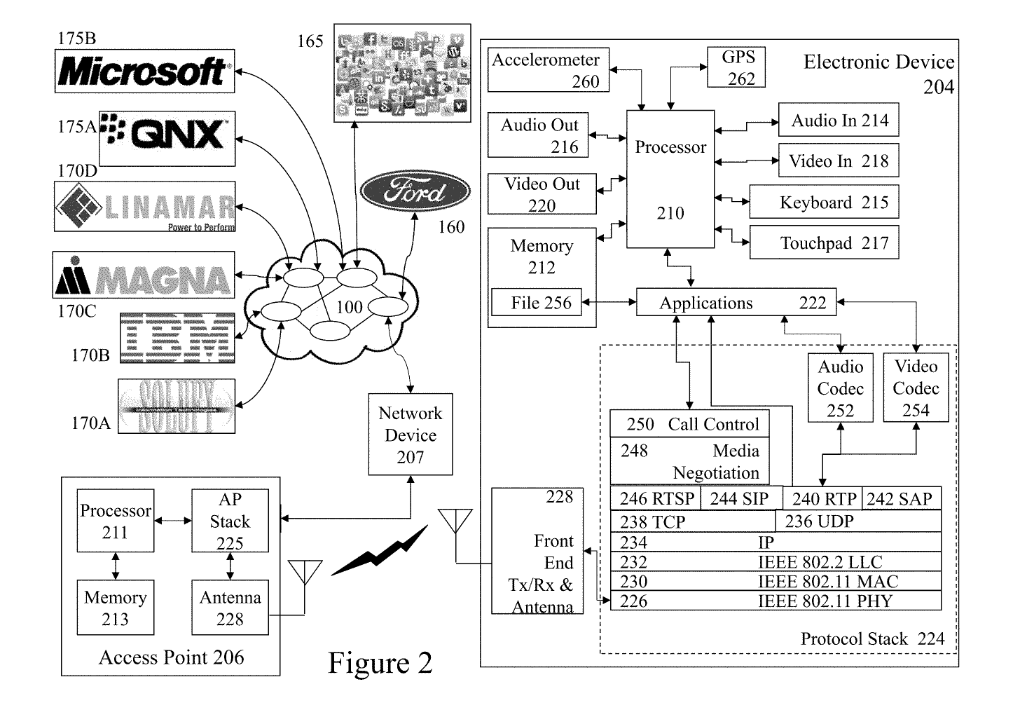

Now referring to FIG. 2 there is depicted an electronic device 204 and network access point 207 supporting DAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein Social Networks (SOCNETS) 165, first and second software providers 170A and 170B respectively, e.g. Solufy™ and IBM™, first and second suppliers 170C and 170D, e.g. Magna™ and Linamar™, and first to second online service providers 175A and 175B respectively, e.g. QNX™ and Microsoft™, as well as first and second servers 190A and 190B.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise, AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 21, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.10, IMT-1000, DSL, Dial-Up, DOCSIS, Ethernet, G.hn, ISDN, MoCA, PON, and Power line communication (PLC).

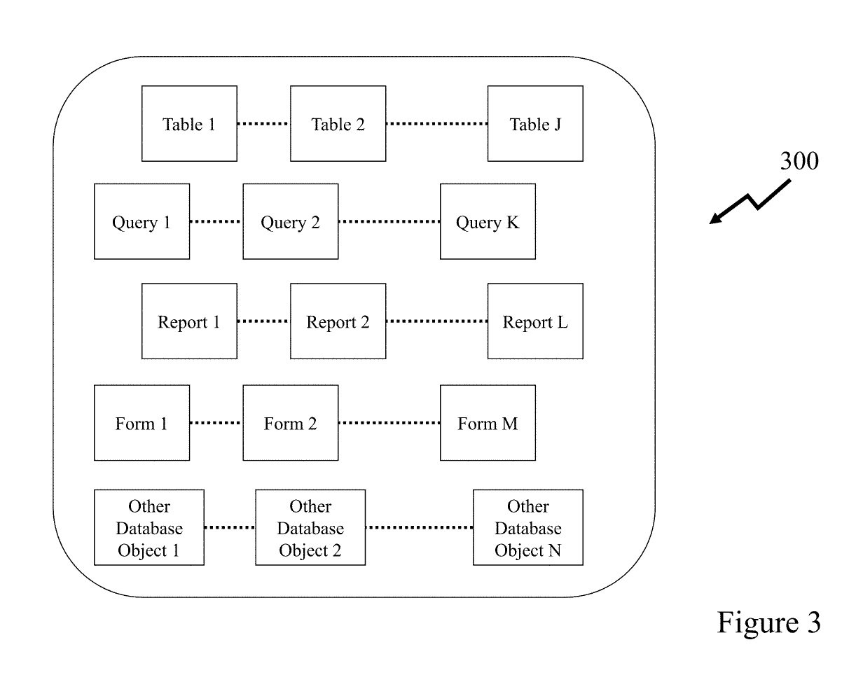

Now referring to FIG. 3 there is depicted a block diagram schematic of a general desktop database 300 associated with a desktop database program having an integrated user interface (UI) according to an embodiment of the invention. Accordingly, database 300 illustrates multiple different types of database objects. These database objects include tables, queries, reports, forms, and other database objects. Databases generally include one or more tables. General databases can also include any number of queries, reports, forms, and other database objects. In the implementation depicted database 300 includes “J” tables, “K” queries, “L” reports, “M” forms, and “N” other database objects. The variables J, K, L, M, and N may be integers of zero or greater. Accordingly, as depicted database 300 includes Table1;Table2; . . . ; TableJ, Query1;Query2; . . . ; QueryK, Report1;Report2; . . . ; ReportL Form1;Form 2; . . . ; FormM, and OtherDatabaseObject1;OtherDatabaseObject2; . . . ; OtherDatabaseObjectN . As described herein above, tables store the data of database 100. The query, report, and form objects provide some view on or some view of at least one table object. The “N” other database objects represent other possible objects that either provide some view on or of at least one table of database 300 or that provide and/or cause some action to occur with respect to database 300. Examples of action-oriented database objects, or actionables, include macros, modules, action queries, scrips, and so forth. Actionables are capable of manipulating or otherwise interacting with data and/or objects without necessarily displaying the data to a user.

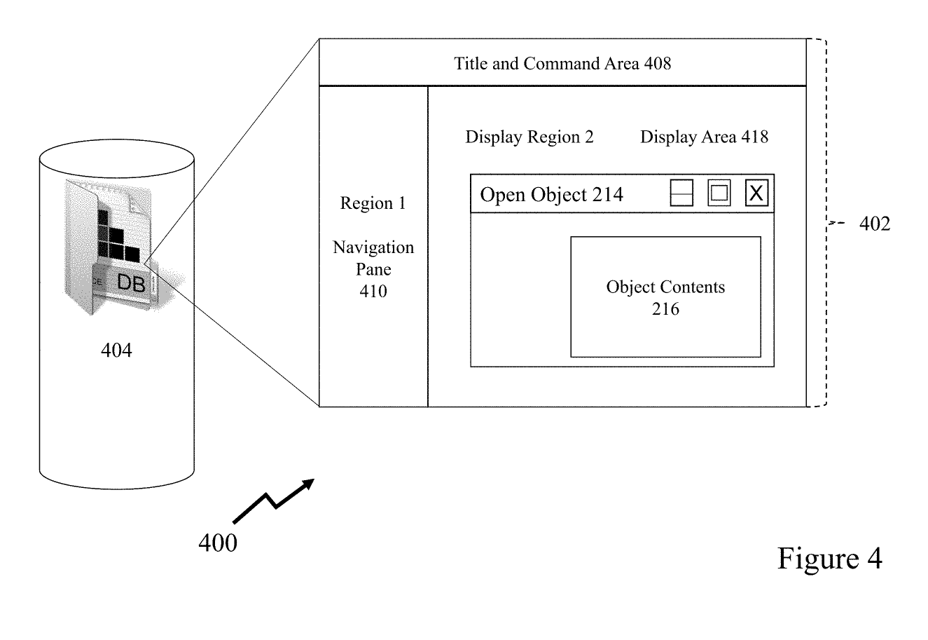

Accordingly, database objects can be divided into at least data source objects and data consuming objects. Data consuming objects can be further divided into at least view objects and database action objects. Database action objects or actionables manipulate or otherwise interact with the data or other database objects of a database. Examples of action objects include macros, modules, action queries, scrips, and so forth. View objects can be further divided into data processing objects, data formatting objects, data input objects, and so forth. Although database 300 includes a diversity of objects as well as an immense amount (also referred to as wealth) of information, it is only truly useful if (and to the extent that) a user can gain access to the information. A database program not separately depicted in FIG. 3 but depicted by database program 404 in FIG. 4 provides access to the underlying database 400. The more useful/flexible/intuitive the database program 404 is then the more useful database 300 can be to a user be it an individual, an organization, an enterprise or a Government. Various database interfaces and interaction schemes, mechanisms, and techniques are known within the prior art which are generally based around one or more GUIs.

Now referring to FIG. 4 there is depicted an exemplary screenshot 400 of a database program 404 having a graphical user interface (GUI) 402 capability. Database program 404, as represented by its main window 402, is illustrated in a navigational or other mode in which an object can be accessed. Main window 402 includes a title and command area 408, a first region 410, and a second region 418. However, main window 402 may alternatively have different regions and areas and/or may otherwise be laid out (e.g., arranged) differently.

Title and command area 408, as illustrated, is located at a top portion or pane of main window 402. Although the accompanying figures and the description herein that references them may illustrate and pertain to specific implementations (e.g., in which an area or region is represented specifically as a pane, a sub-window, or a separate window), it should be understood that graphical areas or regions can be alternatively implemented as a different one or more of a pane, a sub-window, a separate window, and so forth.

In the illustrated navigation or other object-accessing mode, main window 402 of database program 404 includes a first region 410 (e.g., a pane or sub-window of main window 402) that is devoted to a listing of database objects that are currently eligible for accessing. Once a database object has been selected (e.g., focused on or highlighted with a mouse single-click, a maneuvering of a highlight indicator, etc.) within navigation pane 410, the selected database object can be directly activated (e.g., by double-clicking thereon, pressing “Enter”, etc.). Alternatively, database objects can be accessed by keyboarding, by a keyboard combination, by keyboard and mouse combinations, or by another input mechanism (e.g., a menu-based or other action button or keyboard combination as well as by other input devices). Also, multiple database objects may be simultaneously selected and activated and/or otherwise manipulated (e.g., dragged and dropped).

Activation of a selected database object enables access to the database object. For example, all or a portion of the accessed database object may be displayed within second region 418 (e.g., another pane or sub-window) of main window 402 that is devoted to displaying objects. As illustrated, an opened database object is displayed within display area 418 in a sub-window 414 that is entitled “Open Object”. Within the “Open Object” sub-window 414, object contents 416 of the accessed database object are displayed. Although accessing a database object is described in detail above with regard to (i) focusing on or highlighting it and (ii) activating it, database object accessing can be described generically in terms of selecting the database object.

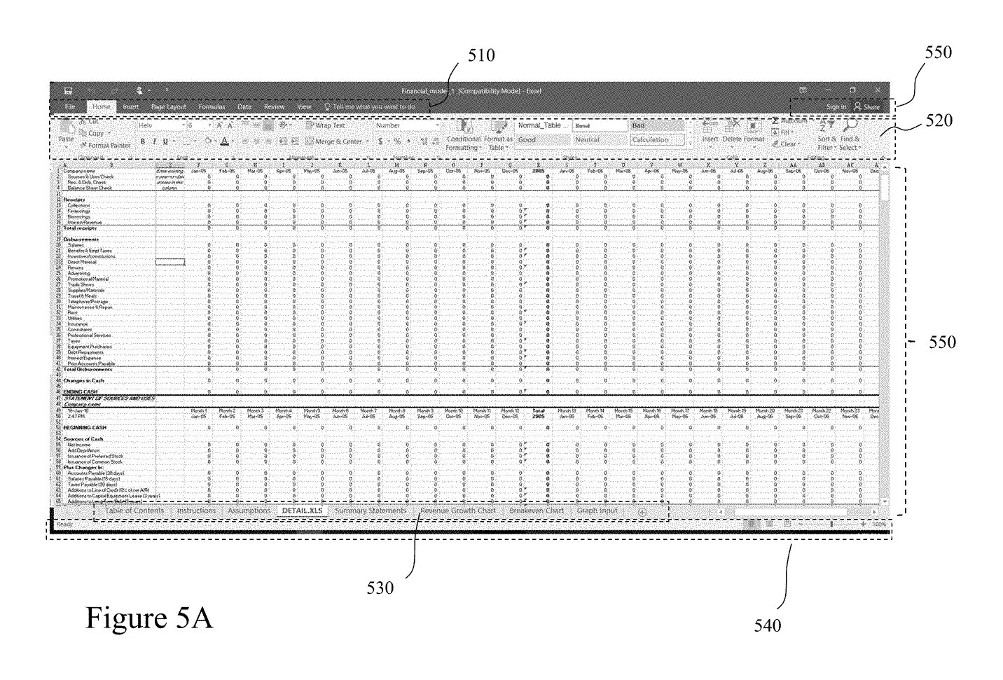

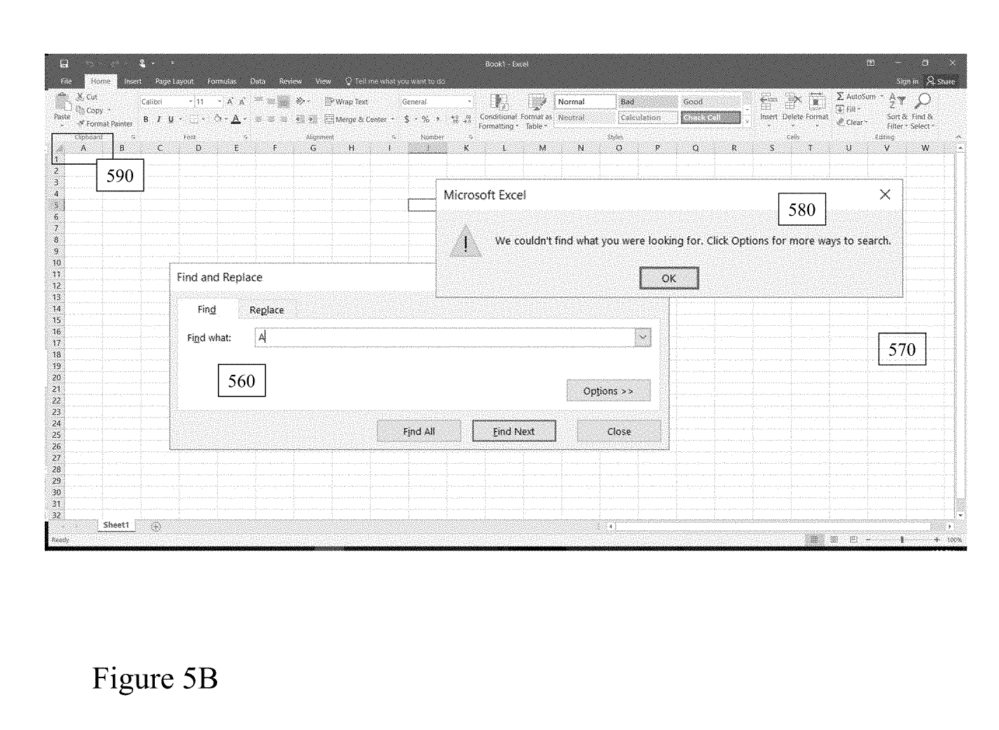

Now referring to FIG. 5 there is depicted an exemplary screen layout of a database grid, in this instance a spreadsheet, presented to a user within a prior art GUI, in this instance Microsoft™ Excel. A spreadsheet may be self-contained in that all the data is stored within the spreadsheet or the spreadsheet may be linked to other spreadsheets that allow data to be viewed, analysed, etc. without the user accessing the source data and potentially corrupting/deleting part of all of it. As depicted in FIG. 5 a workspace 500 is depicted which includes a menu bar 510, a tool bar 520, a current page indicator/page navigator 530, a status line 540, and a window 550. The menu bar 510 displays and invokes, in response to user inputs, a main level of user commands. Menu 510 also invokes additional pulldown menus, as is known in windowing applications. Input line 531 accepts user commands and information for the entry and editing of cell contents, which may include data, formulas, macros, and the like. Page indicator 530 displays the current page and in other embodiments may display the current cursor (i.e., active cell) position. At the status line 540, the underlying system upon which the spreadsheet application is in execution displays information about the current state of the workbook; for example, a “READY” indicator means that the system is ready for the user to select another task to be performed.

The tool bar 520 comprises a row or palette of tools which provide a quick way for the user to choose commonly-used menu commands or properties. In an exemplary embodiment, tool bar 520 includes cut, copy, and paste buttons, a power button tool, a graph tool, alignment buttons, a style list, font buttons, insert/delete buttons, a fit button, and action buttons. Buttons relating to cut, copy and paste allow data and objects to be moved to and from an operating system clipboard. The same actions are also available as corresponding commands in the Edit menu (available from menu bar 510). Tool 520 may also support “power buttons” which allow a user to run spreadsheet macros; in a specific embodiment, power buttons appear as floating objects in a layer above spreadsheet cells. In a similar fashion, a graph tool may create graphs that appear embedded within or above spreadsheet cells in order to displayed selected portions of the data to the user in a graphical/visualization format.

A variety of other functions are available within standard prior art database tools, spreadsheets etc. including those relating to formatting cells, including for example alignment buttons to place cell entries flush left, centered, or flush right, as desired; style lists to specify the style for the active block and may be selected from a plurality of pre-defined styles (e.g., normal, currency, fixed, percent, and the like); font buttons effect font changes, including toggling bold and italic fonts, as well as increasing and decreasing font (point) size. Further, insert and delete buttons permit the user (where their database access rights permit) to insert or delete blocks, rows, columns, and pages. Action buttons provide automated spreadsheet operations, including sorting and summing operations. MicrosoftTM Excel is a general purpose consumer spreadsheet software package but it already can support data in up to 1,048,576 rows by 16,384 columns.

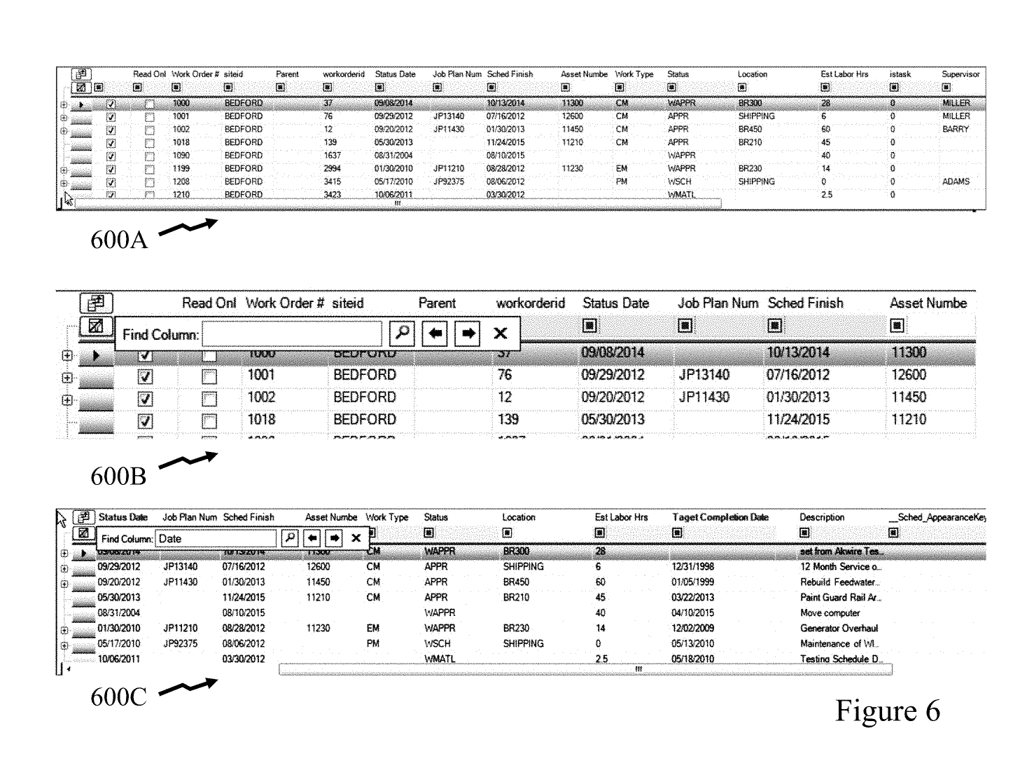

FIG. 6 depicts first to third exemplary user GUI images 600A to 600C respectively for a user accessing and searching a database exploiting a column search feature according to an embodiment of the invention. Within the prior art a search within a database 570, e.g. as depicted in FIG. 5B, then a search dialog 560 is presented to the user wherein the user enters the search term they are looking for, e.g. “A.” As evident this search fails to return any results as indicated by result dialog 580 which as the database was empty is not surprising for that aspect of the search. However, it has not identified column “A” 590 which for ease of presentation was within the window displayed to the user. As noted supra if these columns were named from a stored database then such a search would not return the column position to the user or even identify that a column of that name existed. In other databases, rows as well as columns may be associated with alphanumeric identifiers. Further, as noted supra even with a general purpose consumer spreadsheet software package such as Microsoft™ Excel potentially the user is searching for a specific row in up to 1,048,576 rows or a specific column in up to 16,384 columns.

Accordingly, first to third exemplary user GUI images 600A to 600C respectively in FIG. 6 depict a search according to an embodiment of the invention. Embodiments of the invention may be applied to any grids in any type of application such as a desktop application, a web based (online) application or even a mobile application. Further, embodiments of the invention can be supported no matter on what system or device the application is running from or on. Accordingly, the user starts with a data grid, such as depicted in first GUI image 600A in FIG. 6 wherein data extracted from a database is presented and columns within the database are fielded which in the exemplary database grid are Read Only, Work Order #, siteid, Patent, workorderid, Status Date, Job Plan Num, Sched Finish, Asset Number, Work Type, Status, Location, Est. Labour Hours, isstak, Supervisor etc. Whilst 8 rows of the grid are displayed there may be more, less, etc. and as indicated adjacent to some rows other rows may be hidden as depicted by the cross symbol adjacent to them. Similarly, columns may in other DAPs be hidden and/or made visible by the user or these features may be disabled due to the access rights of the user.

Subsequently, the user may, for example by using a shortcut key such as CTRL+ALT+F, a right-click accessed menu, designated tool button within the grid and/or DAP trigger a Grid Column Search Dialog. Other methods of triggering access to the Grid Column Search Dialog known within the art may be exploited within embodiments of the invention. As depicted in second GUI image 600B a dialog is presented to the user. Whilst the dialog displayed in second GUI image 600B is a minimalistic control it would be evident that alternately this may be a standard Search Dialog commonly used in desktop applications, such as dialog 560 in FIG. 5B, or other dialog/UI known within the art that allows a user to enter alphanumeric content for the search. With the alphanumeric content entered the user can then search and subsequently navigate to subsequent/preceding instances of the alphanumeric content appearing within the column names or exit. Accordingly, second GUI image 600B depicts a search dialog that has the following controls/functionality:

Function 1: A text box for the user to enter parts or all of the desired column name is presented. As the user types in this textbox, the search process is started and the first column that contains this text in its key (i.e. WONUM) or its caption (Work Order #) will automatically be scrolled into view. Importantly, the search process can look at both the column key or its caption, as often standard users do not know the actual field names (column keys) while power users or database administrators (DBAs) may be more used to the field names. Optionally, columns that meet the search “criterion” may have its appearance changed to serve as a visual cue that the current text of their search has been found in their key or caption. In the screenshot below, the text of the column's caption is changed from standard text to bold text with outline. The search process may be initiated immediately after each key press, or after a configurable delay to make it a smoother experience for the user.

Function 2: A “Search” button to re-execute the search or initiate the search if it not automatically initiated.

Function 3: A “Previous” button to move to the previously found column. Clicking this button will scroll the previous found column into view whereas if it is disabled if there are none.

Function 4: A “Next” button to move to the next found column. Clicking this button will scroll the next found column into view, if any whereas if it is disabled if there are none.

Function 5: A “Close” button to close that dialog. When it is closed, the columns return to their original appearance.

Optionally, each of the commands/buttons could have their own shortcut keys if so desired. By default, the window is displayed just below the columns header area, on the left, but this could also be configurable. It would be evident that the user could also move the dialog with a haptic interface, e.g. a mouse, and the application could remember its position.

Optionally, additional buttons and/or functionality may be added including, but not limited to:

Option 1: An option to hide columns that do not meet the search criteria making it easier to see all desired columns in the same view

Option 2: A means to specify multiple search criteria. For example, using a comma as an OR operator, and the pipe character “|” or “:” as an AND operator. For example, columns containing “Sched” or “Targ” may be searched using “sched,targ” as the search string within the search dialog. Optionally, the search may be case sensitive or case insensitive.

Option 3: The search may be set optionally only look at the column keys or captions rather than both.

Option 4: Optionally, the search tool may be configured to allow the user to enter multiple column keys and/or captions wherein those matching the search terms are displayed within a pop-up window, a second window, an overlay or within the main window allowing the user to reduce the filtered database. For example, “TargetCompletion” and “Sched Start” may be entered into two lines resulting in the database columns meeting these criteria being displayed within a new window.

Optionally, the search function may also allow the user to select other functions in combination with the search including, but not limited to, exporting to a datafile, plotting the data, performing one or more operations on the data retrieved. Optionally, the search tool may include Boolean functions for determining search results such as “TargetCompletion AND Sched Start” or “TargetCompletion OR Sched Start” wherein the former will only return data if both columns are present whereas the second will return data if either or both are present. In this manner a user may search large databases with “guesses” at column names as they may be unfamiliar with the database, for example through never accessing it previously or not for an extended period. Optionally, search terms may include wildcard characters such as “*” allowing for example all columns incorporating “START” to be searched with “*START*.” In this manner “SCHED START” may be returned which would otherwise not be identified.

Within other embodiments of the invention the DAP may provide a database visualization engine as a discrete software application apart from the main database tool. Such a discrete DAP visualization software application (DAPVISA) may, for example, provide resources with the ability to view tasks/activities etc. with one or more databases without requiring the full database be accessed. For example, a user with a wearable device may be able to access a database through a DAPVISA that retrieves a limited amount of data from the database thereby allowing the user to access the data in circumstances such as limited memory of the wearable device, limited data rate in a wireless connection etc.

Within the embodiments of the invention described supra in respect of FIGS. 2 to 6 the descriptions address primarily the naming and searching of keys and/or names with respect to columns within the grid, However, it would be evident that within other embodiments of the invention these keys and/or names may relate to rows or other slices/cross-sections through the data within the database.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
providing a database management system in execution upon a computer system comprising at least a microprocessor coupled to a server via a communications network, the server comprising a database;
receiving from a user one or more search terms into a search dialogue provided by the database management system to the user, wherein the search terms relate to at least one of a key, a caption and a name; and
providing to the user a predetermined portion of the database in dependence upon the received one or more search terms.

2. The method according to claim 1, wherein
when the one or more search terms is a key it is a column key of the database;
when the one or more search terms is a caption it is a column caption of the database; and
when the one or more search terms is a name it is a column name of the database.

3. The method according to claim 1, wherein
the one or more search terms relate to a predetermined slice of the database.

4. The method according to claim 1, wherein
the displaying comprises displaying those portions of the database within one or more columns forming a predetermined portion of the database identified by the one or more search terms.

5. The method according to claim 1, wherein
displaying comprises generating an overlay to the database management system and presenting within the overlay those columns within the database having the at least one of the key, the caption, and the name matching the one or more search terms entered by the user.

6. The method according to claim 1, wherein
the at least one of the key, the caption and the name relates to an identifier associating content to a predetermined slice of the database which is at least one of not displayed to the user when the predetermined portion of the database is displayed to the user or not searchable via a conventional SQL based database application.

7. The method according to claim 1, wherein
the predetermined portion of the database comprises data associated within only the fields associated with the one or more search terms.

8. The method according to claim 1, wherein
providing to the user a predetermined portion of the database comprises displaying that data which forms part of the database within each column of grid relating to the database that matches a search term within the plurality of search terms.

9. A system comprising:
an electronic device coupled to a communications network executing a database management application stored within a non-transitory memory of the electronic device;
a remote server coupled to the communications network;
a database stored within the memory; wherein
the database management software comprises executable computer instructions associated with a process comprising the steps of:
receiving upon the electronic device from the user one or more search terms via a search dialogue provided by the database management application to the user, wherein the search terms relate to at least one of a key, a caption and a name;
retrieving a predetermined portion of the database from the remote server in dependence upon the received one or more search terms; and
displaying the predetermined portion of the database to user upon the electronic device.

10. The system according to claim 9, wherein
when the one or more search terms is a key it is a column key of the database;
when the one or more search terms is a caption it is a column caption of the database; and
when the one or more search terms is a name it is a column name of the database.

11. The system according to claim 9, wherein
the one or more search terms relate to a predetermined slice of the database.

12. The system according to claim 9, wherein
displaying comprises displaying those portions of the database within one or more columns forming a predetermined portion of the database identified by the one or more search terms.

13. The system according to claim 9, wherein
displaying comprises generating an overlay to the database management system and presenting within the overlay those columns within the database having the at least one of the key, the caption, and the name matching the one or more search terms entered by the user.

14. The system according to claim 9, wherein
the at least one of the key, the caption and the name relates to an identifier associating content to a predetermined slice of the database which is at least one of not displayed to the user when the predetermined portion of the database is displayed to the user or not searchable via a conventional SQL based database application.

15. The system according to claim 9, wherein
the predetermined portion of the database comprises data associated within only the fields associated with the one or more search terms.

16. The system according to claim 9, wherein
providing to the user a predetermined portion of the database comprises displaying that data which forms part of the database within each column of grid relating to the database that matches a search term within the plurality of search terms.
